(19) United States
(12) Patent Application Publication
(10) Pub. No.: US 2026/0149601 A1
(43) Pub. Date: May 28, 2026

(54) METHOD TO SCALE DNSSEC USING ATTESTATION FOR INTEGRITY AND DATA PROVENANCE

(71) Applicant: Kathleen M. Moriarty, Arlington, MA (US)

(72) Inventor: Kathleen M. Moriarty, Arlington, MA (US)

(21) Appl. No.: 19/403,509

(22) Filed: Nov. 28, 2025

Related U.S. Application Data
(60) Provisional application No. 63/725,868, filed on Nov. 27, 2024.

(51) Int. Cl. H04L 9/32

(52) U.S. Cl. CPC H04L 9/3255; H04L 9/3263

(57) ABSTRACT

Digital records including Domain Name System records are signed using a root of trust that is local to a DNS server using attestation. This relieves the DNS server of key management and certificate operations. Digitally signing records using attestation with keys generated by a local root of trust enables security in a DNS system to be scaled more efficiently and effectively. DNS records are signed using attestation keys and are published. This allows the digital signatures to be verified using a local root of trust when the records are used.

### FIELD OF THE INVENTION

Embodiments of the present invention generally relate to domain name system security (DNSSec). More particularly, at least some embodiments of the invention relate to systems, hardware, software, computer-readable media, and methods for providing and scaling DNSSec using attestation for data integrity and data provenance.

### BACKGROUND

Domain Name System (DNS) is, simply stated, a system configured to translate readable domain names (e.g., www.example.com) into an IP (Internet Protocol) IP address (e.g., 172.172.14.504). When a user types a domain name into their browser, a DNS server is queried for the corresponding IP address. The DNS server responds with an IP address corresponding to the domain name. The browser then connects to the website using the IP address received from the DNS server.

Like any other system, there is a need to provide security to ensure that the responses and communications are authentic. A common attack is DNS spoofing where a malicious actor tries to trick a DNS server into returning a false IP address for a domain name.

Domain Name System Security or Domain Name System Security Extensions (DNSSec) is a way to protect against spoofing and other security concerns. DNSSec has been defined for decades, but has not achieved widespread adoption. The reasons include the difficulty of providing DNSSec on records and maintenance of DNS with DNSSec implemented.

More specifically, the primary goal of DNSSec is to provide security such as ensuring authenticity and integrity. Authenticity refers to ensuring that data comes from the correct source and integrity relates to ensuring that data tampering has not occurred. Digital signatures and cryptography, which requires keys (e.g., public/private key pairs), are part of enabling DNSSec on DNS servers.

Introducing digital signatures and cryptography, however, comes with substantial challenges. The challenges that make scaling DNSSec very difficult include complex key management, chain of trust concerns, and larger responses (e.g., due to adding digital signatures to DNS records), among others.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a DNS server that includes a local root of trust;

FIG. 2 discloses aspects of a DNS server that includes a local root of trust;

FIG. 3 discloses aspects of a method for proving provenance and integrity using a local root of trust;

FIG. 4 discloses aspects of providing provenance and integrity in a DNS server and/or a distributed DNS system; and

FIG. 5 discloses aspects of a computing device, system, or entity.

### DETAILED DESCRIPTION OF SOME EXAMPLE EMBODIMENTS

Embodiments of the invention relate to domain name system security (DNSSec). More particularly, embodiments of the invention relate to scaling DNSSec using attestation for integrity and data provenance. Attestation from a root of trust, such as through a local Trusted Platform Module (TPM), or a remote attestation process using an entity attestation token (EAT) overcome the difficulties of providing or scaling DNSSec.

DNSSec is configured to add security to DNS records using cryptography. The DNS system refers, in one example, to a hierarchical system that includes DNS servers such as, by way of example, root DNS servers, TLD (Top Level Domain) servers, authoritative DNS servers, resolver DNS servers, and the like.

A DNS system may may also be organized using zones. A zone typically refers to a portion of a domain namespace that is managed by a particular organization or DNS server. A zone is distinct from a domain. In one example, the primary DNS server (or authoritative DNS server) is a server that typically stores zone files. Zone files are, in one example, text files that store DNS records, which may include mappings of text to IP addresses (e.g., www.example.com->93.184.216.34). The records that are signed, in one example, are included in the zone files. The digitally signed records can also be stored in other ways for servers that generate the zone information on the fly.

When a PKI (Public Key Infrastructure) hierarchy, including cryptographic keys (e.g., private/public key pairs), is added to the DNS system, key management becomes a serious problem. Even if the PKI hierarchy is secure and trusted, implementation hurdles including distributed configurations and maintenance are hurdles to PKI implementation in DNS scenarios.

DNSSec provides integrity and authentication by digitally signing DNS records. In one example, a resolver DNS server may request a record. The resolver DNS server may receive the record and a digital signature from another DNS server. The resolver DNS server retrieves the relevant public key to verify the digital signature. If the digital signature is verified, then the record is authentic in one example. In one example, because multiple servers may be involved, the chain of trust is verified. In the context of DNS, the chain of trust may involve certificates and keys associated with a root server, a TLD server, an authoritative server, and the like.

As previously stated, using a PKI infrastructure in this type of arrangement can be overwhelming and complex. In contrast to conventional DNSSec implementations using a PKI infrastructure alone, embodiments of the invention relate to a root of trust that may be a TPM (Trusted Platform Module) using attestation. Attestation, in general, relates to proving that a computer or other device or system is trustworthy. In one example, attestation may work in conjunction with a TPM. In one example, when a computer boots, various aspects of the booting process are measured and stored (e.g., as hashes). A private attestation key is used to digitally sign the measurements. This allows the signed measurements to be verified and enables the device to be trusted.

In an example embodiments, a DNS server is equipped with a root of trust. Thus, the digital signature applied to DNS records is performed by a root of trust, TPM, vTPM, or alternate roots of trust. A record is generated and placed in the DNS data store to disclose the signature source. The DNS record could be formulated based on Entity Attestation Results, or a derivative, a pointer to a descriptive record, or a similar DNS record that includes information about the origin and trustworthiness properties of the signature.

In one example, embodiments of the invention relate to digitally signing DNS records, following DNSSec standards, by altering the signing source to enable automation at scale. Using attestation, records can be signed from a root of trust on the system hosting DNS content rather than through public/private key pairs issued from a PKI (Public Key Infrastructure) hierarchy, local PKI, or raw public/private key pairs.

While the use of a PKI hierarchy may be more secure, a PKI hierarchy has not gained widespread adoption due to implementation hurdles that require distributed configuration and maintenance. To account for the varying level of security offered between signature sources, a record could be added to the DNS to either directly provide information on the signature source and properties or a pointer to information on the signature source and its security properties.

The root of trust may be a TPM or other root of trust used with attestation, including remote attestation. If a TPM, the server will have a hardware based immutable key where signing keys for DNS and DNSSec operations can be generated and used. Because the key is resident on the hardware, trust is placed in the issuance and protection of the immutable key. Existing or new methods can be used to describe the trustworthiness properties of the signing keys to differentiate from records signed through a more rigorous process, such as through PKI issued key pairs from a trusted certificate authority.

Attestation from a root of trust has been used to validate posture of firmware as well as properties of protocol sessions, such as integration into the Transport Layer Security Protocol (TLS) protocol to assure properties of the runtime environment of the connecting systems. To assurance provenance of DNS data using DNSSec (RFC4033, 2005), this typically relies upon use of PKI certificate authority issued key pairs designated for that purpose in order to have some authority over the issuance of those keys to the responsible entity.

Data provenance is an area under exploration in industry with new protocols emerging, including C2PA (C2PA, 2023). C2PA is limited in use to image files and relies upon traditional PKI for the certificates and key pairs used in the digital signature process.

Attestation for data provenance is not used due to the nature of a TPM or other root of trust being local to a system. This falls outside of how industry forms trust relationships to assure content. PKI hierarchies with trusted root servers or signed key chains in the case of Pretty Good Privacy (PGP) are more commonly used, hence the methods to establish trust for data provenance using attestation is not obvious.

Establishing trust for a global system such as DNS that has distributed implementations of DNS records that tie back to a top level domain is established in embodiments of the invention. Traditional trust hierarchies have been used to date for DNSSec implementations to assure record integrity and provenance. The reason for this is the verification process and established norms for trust relationships tied back to PKI roots of trust are well understood and established.

Embodiments of the invention enable DNS (and other data types) to use attestation for integrity and data provenance in order to reduce the distributed complexity placed on end users, administrators, or the owners of data. The complexity using current PKI hierarchies to establish trust include the requirement to attain, install, and maintain certificates and key pairs can be eliminated through a change in method to use attestation from a root of trust.

Embodiments of the invention relate to an attestation method to provide a traceable method to digitally sign DNSSec records that is easier to automate and may allow for greater adoption of DNSSec while providing integrity protection and data provenance on DNS records. The signed content in this instance aligns with existing implementations with use of the RRSIG (resource record signature) record to publish this signed data and methods to validate against the public key for the key pair used.

Embodiments of the invention include digitally signing data (e.g., DNS records) using attestation from a localized root of trust and provides assurance of integrity and provenance of data (e.g. DNS records) at runtime. If the root of trust is a TPM, the hardware is tamperproof with keys burnt into the chip by the manufacturer. Instead of a traditional PKI hierarchy, using the TPM (or other root of trust), the hierarchy for the trust root burnt into the hardware (e.g. endorsement key (EK), EKCert) is to the manufacturer and the chip is able to generate new keys based off of the keys on the chip, such as the attestation identity key (AIK) or attestation key (AK) and storage root key (SRK).

The TPM provides an alternate hierarchy for PKI tied to a manufacturer (or other entity) through the key embedded in the root of trust, the EK for the TPM. While evidence is needed to ascertain the trust level for a signature on a record, and the IETF Entity Attestation Results (or a similar method appropriate for the type of attestation and root of trust used) can be used to formulate the information needed to convey the trustworthiness of the signing keys and root of trust. A DNS record or other method to publish the information about the root of trust can be used to maintain the trustworthiness and verifiability of DNSSec records within the DNS protocol, alleviate the need for additional external verifications for every entity interested to validate the trustworthiness of DNS records.

The chain of trust for digitally signed DNS records may be, by way of example only, as follows. The TPM is a starting point and includes an EK key burned into the hardware. The EK key can prove the identity of the TPM, but is not used to sign data in one example. Thus, the EK and/or associated certificate can be a root of trust for identity. The EK key may be used to generate an attestation identity key or attestation key. The AIK key or AK key is certified by an authority that trusts the EK.

The AIK key is a signing key used to digitally sign DNS records. Thus, a DNS record may be digitally signed by an AIK key. The receiving client can perform verification based on the chain of trust.

Embodiments of the invention include a capability to provide assurance at runtime for the continued integrity and provenance of the DNSSec records with an option for the publication of an updated status on the verification process. Embodiments of the invention include the ability to assure the ongoing integrity and provenance of DNSSec records signed using attestation.

A method to digitally sign DNS records, following DNSSec standards, alters the signing source to enable automation at scale. By using attestation, records can be signed from a root of trust on the system rather than through another PKI hierarchy. Even assuming that the PKI hierarchy may be more secure, it has not gained widespread adoption due to implementation hurdles. To account for the varying level of security offered, a record could be added to the DNS to either directly provide information on the signature source or a pointer to the signature source and its security properties.

The root of trust may be a TPM or other root of trust used with attestation, including remote attestation. If a TPM is used, the server will have an immutable key where signing keys for such operations can be generated and used. Since the key (e.g. EK) is resident on the hardware, trust is placed in the issuance and protection of the immutable key. The TPM uses the EK key to generate key pairs (Attestation keys) used to support attestation operations, such as the digital signature placed upon the quote generated on evidence. In this case the evidence can be the DNS record or content to be assured with a hash (quote) and a digital signature using the generated private AIK key. The trustworthiness properties of the signing keys can be described to differentiate from records signed through a more rigorous process. Example methods provide a traceable method to sign DNS records that is easier to automate and may allow for greater adoption of a method that provides integrity protection on DNS records. Publication of the public key and key properties also aids in answering questions on trustworthiness of the keys used to sign data under the current industry standards, for instance if keys originating from a trusted certificate authority, local certificate authority, or raw public/private key pairs are used. The public key should be published similarly to how public keys are currently made available via DNSSec to conform to the existing validation process. A record of public keys used to sign DNSSec records may be made available through a number of ways (e.g. transaction log, distributed ledger, publication in DNS) and should include enough identifying information to automate the verification of content that was previously signed.

If a TPM is used, content generated by the TPM can be signed by an issued Attestation Identity Key (AIK). This provides provenance information about any signed content. Therefore in this method, the TPM will generate a hash of the record information (e.g., DNS record being transmitted to a client) to ensure integrity of that content and the resulting hash will be signed by the AIK. The signature can be validated in order to verify the provenance of the DNS record residing on that DNS server and signed by a key tied to the immutable key in the TPM (or other root of trust).

If DNS records have not been altered, the data can also be verified at runtime to provide a higher level of assurance of the provenance and integrity of the DNS records. In this instance, at set or random intervals, the same process will take place, generating a new hash of the DNS record content and this will be signed by the AIK. The signature and hash will be verified against an expected policy (a set of so-called golden values) including the measurement (e.g. hash) on the expected content by either a local or remote relying party. This additional validation process is unique to attestation and provides a method for the maintainer of the DNS zone information to discover possible compromises or breach of change control procedures in a timely manner internal to their processes.

To provide a higher level of assurance on this method and the integrity of the DNS records, a verification process at runtime can be used. This verification process may help to alleviate concerns on the security of using attestation from a local root of trust as opposed to a PKI hierarchy. When the DNS records are created or altered, a set of policies, including the expected measurements of the DNS records can be created. These policies can be used at runtime intervals (periodic or random) to verify the DNS records are as expected. At runtime, a quote (generating a hash of the current content) will be created in the TPM or other root of trust and digitally signed with the appropriate key (e.g. AIK or AK). The relying party, local to the server or through a remote attestation process (e.g. possibly using EAT) will be used to validate the signature on the content, the trustworthiness data published about the keys and certificates used, perform path validation, and the current hash against the expected values in defined policy or set of golden values (containing both configuration policy information and measurements including hash values). If a key generated from the root of trust is used, this is also verified to assure provenance.

The ongoing assurance process for integrity and provenance at runtime may be separate from the publication process for the attestation signed records and the trustworthiness of the signing keys. This provides a mechanism to scale and automate DNSSec as well as a process that can occur on the hosting server to ensure content validation and alignment to zero trust properties to assure data and integrity by design. This capability aids in zero trust implementation for DNS integrity protection as it uses system resources that allow for granular verification of data (may be used for data types other than DNS) for integrity aiding in the ability to detect compromises early and prevent lateral movement.

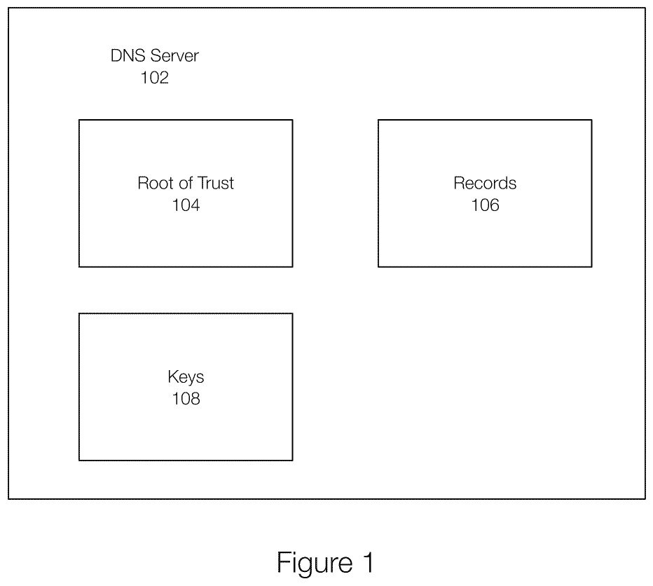

FIG. 1 illustrates an example of a DNS server 102 implementing embodiments of the invention. The DNS server 102 may be representative of various types of DNS servers (e.g., TLD servers, root server, authoritative server, resolver server). In this example, the server 102 may include a local root of trust 104. The root of trust 104 may be a TPM, vTPM, or the like. A key 108 (private/public pair) may be generated or used in security functions, digital signing operations, and other operations. Records 106 may include existing records stored on or available to the server 102 or records generated at the server 102. This allows attestation to be used to establish provenance and integrity of the records 106.

In this example, operations are performed using the root of trust 104 with attestation. The root of trust 104 may generate keys used in the security or other operations. More specifically, when the root of trust 104 includes a TMP, the server 102 may have immutable keys for operations that require signing. Because the key (e.g., an EK) is resident in hardware, trust is placed in the issuance and protection of the immutable key.

Rather than relying on an external PKI system, the server 102, in effect, includes a localized PKI system or root of trust. In some examples, the root of trust 104 (e.g., TPM) can be used in a TPM environment to verify system integrity (booting, firmware, etc.), which is an example of attestation. Records generated by or available at the server 102 can be verified as well by the root of trust 104 using the keys 108. Records stored on the server 102 can be digitally signed using keys at the server 102.

As previously stated, PKI infrastructure and DNSsec face implementation challenges that are related, in part, to key management. The need to store keys, protect keys, rotate keys, synchronize keys across servers, and the like is a significant challenge. The challenge of PKI in DNSsec is further complicated by the hierarchical structure of DNS servers. This may result in security problems at various points of operation.

By implementing a root of trust locally on the DNS server 102, keys 108 can be local to each DNS server and can be generated locally. Data provenance and other security requirements can be satisfied and implemented locally on the DNS server 1-2. This introduces scalability and eliminates the dependence on (and challenges of) an external PKI system and distributed key management.

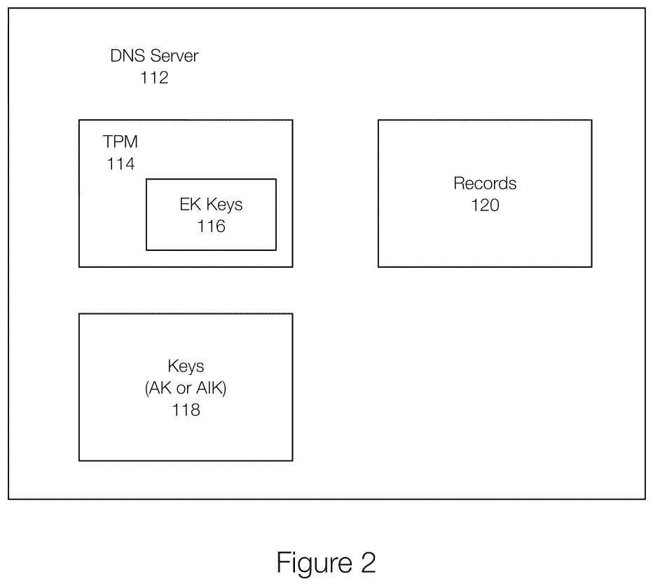

FIG. 2 illustrates another example where the root of trust is a TPM. In this example, the DNS server 112 includes a TPM 114. EK keys 116 are resident on the TPM 114 and the private EK key does not leave the TPM 114. The AK or AIK keys 118 are generated using the EK keys 116.

The EK keys 116 are typically created when the TPM 114 is manufactured. Thus, the EK keys are a permanent part of the DNS server 112 and uniquely identify the TPM 114 hardware. The EK private key is stored inside the TPM 114 and never leaves the TPM 114 in one example. The EK Keys, which include a private key and a public key, may include or be associated with an EK certificate. This is signed by the manufacturer and may include the EK public key. The EK keys may be used in remote attestation.

In one example, the keys (AK or AIK) 118 may be generated using the EK keys 116 and include a private/public pair. The private AK key does not leave the TPM 114 and may be used to sign data such as DNS records. The public key can be used to verify attestation signatures.

In the context of DNSSec, embodiments of the invention digitally sign DNS records or other data from a root of trust that is part of the system hosting the DNS records or other data. A TPM (or other system) can be a root of trust at least because the EK keys are embedded in the hardware and therefore identify the hardware. This allows the integrity of the system (the DNS server) and keys 118 to be verified.

In one example, records at the DNS server 112 are digitally signed using the keys 18 and published to the records 120. Thus, the records 120 may include digitally signed DNS records whose signatures can be verified and go back to the local root of trust (e.g., the TMP 114). This allows each DNS server to act independently of other DNS servers. If a DNS record is returned via a chain of DNS servers, each link can be verified independently based on the corresponding local roots of trust.

More specifically, a TPM provides a root of trust because the TPM includes permanent asymmetric keys that are unique to the hardware. This allows the TPM to prove that the TPM and the DNS server are authentic. Keys generated inside the TPM (attestation keys) can be used to sign content or data such as DNS records. This allows a chain of trust to be created with respect to a localized root of trust.

A DNS record or other accessible information store is created to include the properties of a key used to sign DNSSec records, allowing for a range of options that may include varying levels of security. This method may be used alongside existing DNSSec implementations in order to expand adoption of the overall protocol specification and may be considered an extension.

DNSSec records may be signed using attestation, enabling automation of this function. This method also removes the key distribution process as the key is stored locally on the sever and additional keys for signing are generated off of that immutable hardware if a TPM is used for this function.

DNSSec signed records may be verified at any point during runtime, by having the root of trust provide a quote on the current content, creating a hash value, and signing the resulting quote creating a digital signature. The hash value will be compared against expected values (also known as golden values) in a verification process for the type of attestation and root of trust used.

In one example, this validation or verification may be local to the server running DNS services, managing zone files and DNSSec records, where the policy is maintained internal to software with the possibly of publishing a notification of continued compliance to expected values. The process to maintain the set of policies should be tied to change management practices to ensure updates to the policy set of measurements is updated as appropriate. If a discrepancy is found, a range of actions can be taken, including but not limited to alerting administrators by any number of options, publishing a notification to a limited group or publicly into the DNS, automating a revision back to a prior state with records that match the expected values, a system or process restart (or moving a workload), etc.

In another example, the verification may be performed though a remote attestation process where the expected policy and measurements are maintained by a relying party who performs the validation or verification.

In another example, the policy of expected values and measurements may be published to a public transparency log that may be a distributed ledger and that distributed ledger could be part of a blockchain or just a distributed ledger.

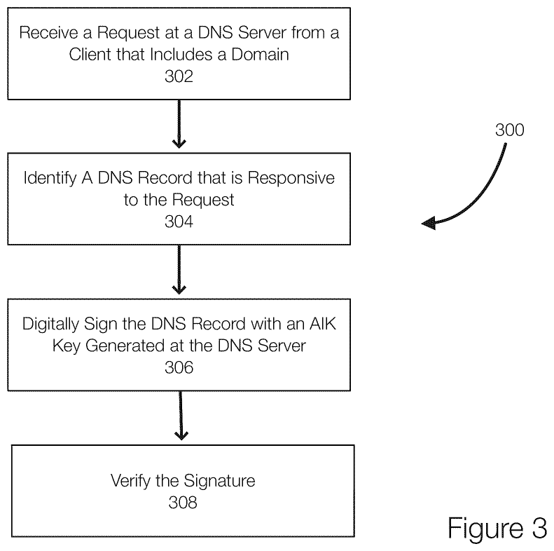

FIG. 3 discloses aspects of a method for providing integrity and provenance in a DNS system. The method 300 includes receiving 302 a request at a DNS server from a client The request may include a domain name, such as www.example.com. The DNS server may identify 304 a DNS record that is responsive to the request. The DNS record is digitally signed 306 by the DNS server using, by way of example, an AIK key generated by a root of trust at the server.

The client can verify the signature 308 or the chain of trust. If the signature is valid, the client understands that the data was resident on the DNS server. Further, the chain of trust leads to the TPM on the DNS server, which further proves that the server is a valid DNS server.

Attestation, which is a process using TPM keys, can be used to prove integrity and provenance. As previously indicated, signed DNS records can be verified by having the root of trust provide a quote on the current content. The quote, which may include a hash value of the current content, can be compared against golden values in a verification process for the type of attestation and root of trust.

The method 300 may be more complex and depend on how the DNS record is identified. For example, if the requested DNS record is not cached at a resolver, it may be necessary to perform a full resolution by querying other DNS servers. For example, a root server may be queried to identify TLD name servers. The TLD server may be queried to identify an authoritative name server for example.com. The authoritative name server may be queried for the domain's actual DNS records.

In each of these communications, it may be possible to use localized roots of trust at each of the servers. Because the roots of trust are present at each of the servers involved in resolving a DNS request, integrity and provenance can be demonstrated at each step. This advantageously removes the need to manage a PKI hierarchy.

This further allows a server to generate keys using a local root of trust, perform signing operations on records at the server using the generated keys, and perform at least provenance operations using attestation and the keys.

In one example, DNS records available at a DNS server (of any type) can be digitally signed with a local root of trust. When a record is requested and delivered, the record is already signed and can be verified by the client back to the local root of trust at the DNS server. In one example, this relieves a DNS system from having to share and manage keys across multiple DNS servers and provides more efficient key management and more efficient operation while still providing integrity and provenance.

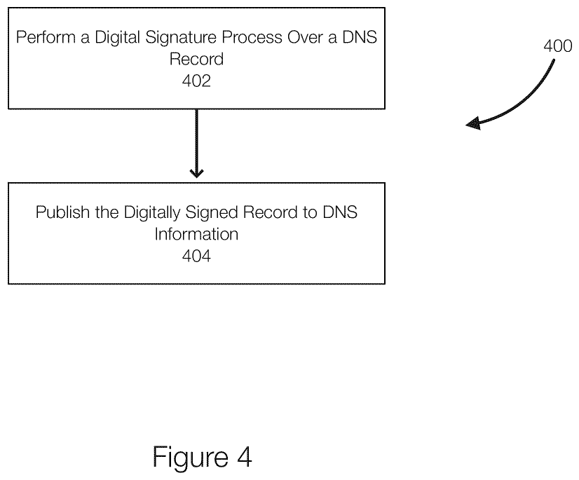

FIG. 4 discloses aspects of providing provenance and integrity at a DNS server and/or in a distributed DNS system. The method 400 is discussed in the context of DNS records, buy may be used for other systems and scenarios to provide provenance and integrity. The servers may be stand-alone servers, distributed servers, or the like. The method 400 includes performing 402 a digital signature process over a DNS record at a DNS server to generate a digital signature using an attestation key generated by a local root of trust. The attestation key may be generated by a local root of trust using a hardware burned in specific key. The digitally signed record can be published 404 to DNS information.

In one example, the DNS information at the DNS server may be of any time typically stored by a DNS server such as a hosts name, an IP address, a DNS artifact, or other DNS record or combination thereof. By publishing this information, any DAN record requested by a client can be verified via the local root of trust. In one example, this allows provenance and integrity to be provided locally, without having to prove provenance through a chain of multiple DNS servers. Rather, a DNS record can be verified by the requesting client from the DNS server. Even in a chain of DNS servers. A requesting DNS server can verify the digital signature independently.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, DNS operations, root of trust operations, attestation operations, resolving operations, key generation operations, integrity and provenance operations, and the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. More generally however, the scope of this disclosure is not limited to employment of any particular type or implementation of cloud computing environment.

In addition to the cloud environment, the operating environment may also include one or more clients or servers that are capable of collecting, modifying, and creating data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Example embodiments are applicable to any system capable of storing and handling data, including various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a request for an IP (Internet Protocol) address at a server from a client, wherein the request includes a domain name, identifying a record that is responsive to the request, digitally signing the record with a digital signature using an attestation key generated by a local root of trust at the server, and transmitting the digitally signed record to the client, wherein the client verifies the digital signature.

Embodiment 2. The method of embodiment 1, wherein the server is a DNS (Domain Name Server) server.

Embodiment 3. The method of embodiment 1 and/or 2, wherein the client verifies a chain of trust associated with the digital signature.

Embodiment 4. The method of embodiment 1, 2, and/or 3, wherein the local root of trust is a trusted platform module or a virtual trusted platform module.

Embodiment 5. The method of embodiment 1, 2, 3, and/or 4, wherein the attestation keys are generated using endorsement keys.

Embodiment 6. The method of embodiment 1, 2, 3, 4, and/or 5, further comprising including properties of the attestation keys in the records, wherein the properties identify a level of security for the record that is digitally signed using the attestation keys.

Embodiment 7. The method of embodiment 1, 2, 3, 4, 5, and/or 6, wherein the record is signed using attestation to enable automation of digitally signing the record.

Embodiment 8. The method of embodiment 1, 2, 3, 4, 5, 6, and/or 7, wherein digitally signing using attestation relieves the server of performing a key distribution process.

Embodiment 9. The method of embodiment 1, 2, 3, 4, 5, 6, 7, and/or 8, further comprising verifying signed records at any point during runtime.

Embodiment 10. The method of embodiment 1, 2, 3, 4, 5, 6, 7, 8, and/or 9, wherein the root of trusts provides a quote on current records that includes a hash value for the current records, and digitally signs the quote, wherein the current records are validated by comparing the hash value to a golden value.

Embodiment 11. The method of embodiment 1, 2, 3, 4, 5, 6, 7, 8, 9, and/or 10, wherein the validation is local to the server, wherein the server is running DNS services, managing zone files and DNSSec records.

Embodiment 12. The method of embodiment 1, 2, 3, 4, 5, 6, 7, 8, 9, 10, and/or 11, wherein further comprising performing the validation through a remote attestation process wherein expected values are maintained by a party that performs the validation.

Embodiment 13. The method of embodiment 1, 2, 3, 4, 5, 6, 7, 8, 9, 10, 11, and/or 12, wherein the golden value is published to a transparency log.

Embodiment 14. A method comprising performing a digital signature process over a DNS record at a DNS server to generate a digital signature using an attestation key generated by a local root of trust at the server, and publishing the digitally signed record to DNS information at the DNS server, wherein a client can verify the digital signature of the DNS record.

Embodiment 15. The method of 14 further comprising the method of embodiment 2, 3, 4, 5, 6, 7, 8, 9, 10, 11, 12, and/or 13.

A system, comprising hardware and/or software, operable to perform any of the operations, methods, or processes, or any portion of any of these, disclosed herein.

Embodiment 15 A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

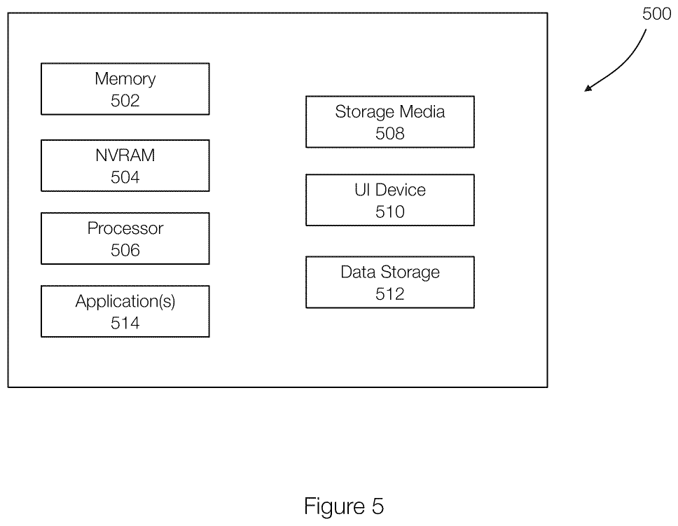

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 506 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may represent any type of DNS server, a DNS system, a distributed DNS system, or the like.

The described embodiments are to be considered in all respects only as illustrative and not restrictive. All changes which come within the meaning and range of equivalency of the claims are to be embraced within their scope.

What is claimed is:

1. A method comprising:
performing a digital signature process over a DNS record at a DNS server, to generate a digital signature using an attestation key generated by a local root of trust at the server; and
publishing the digitally signed record to DNS information at the DNS server, wherein a the digital signature of the DNS record is verifiable by a client.

2. The method of claim 1, wherein the server is a DNS (Domain Name Server) server and wherein the DNS record is a hostname, a domain a DNS artifact, a mapping of a name to IP address, a zone file, or a set of DNS records or a combination thereof.

3. The method of claim 1, wherein the client verifies a chain of trust associated with the digital signature.

4. The method of claim 1, wherein the local root of trust is a trusted platform module or a virtual trusted platform module.

5. The method of claim 1, wherein the attestation keys are generated using endorsement keys.

6. The method of claim 1, further comprising including properties of the attestation keys in the records, wherein the properties identify a level of security for the record that is digitally signed using the attestation keys.

7. The method of claim 1, wherein the record is signed using attestation to enable automation of digitally signing the DNS record that is repeatable at specified or non-specified intervals.

8. The method of claim 7, wherein digitally signing using attestation relieves the server of performing a key distribution process.

9. The method of claim 1, further comprising verifying signed records at any point during runtime.

10. The method of claim 9, wherein the root of trust provides a quote on current records that includes a hash value for the current records, and digitally signs the quote, wherein the current records are validated by using the public key associated with the private key used to sign the current records, and information about the key pair is to determine a trustworthiness of the signature and the current records signed.

11. The method of claim 10, wherein the validation is local to the server, wherein the server is running DNS services, managing zone files and DNSSec records.

12. The method of claim 10, further comprising performing the validation through a remote attestation process wherein expected values are maintained by a party that performs the validation.

13. The method of claim 10, wherein the signature or a golden value is published to a transparency log.

14. A non-transitory storage medium having stored therein instructions that are executable by one or more hardware processors to perform operations, the operations comprising:
performing a digital signature process over record at a server, to generate a digital signature using an attestation key generated by a local root of trust at the server; and
publishing the digitally signed record to information at the server, wherein a client can verify the digital signature of the record.

15. The non-transitory storage medium of claim 14, wherein the server is a DNS (Domain Name Server) server and wherein the record is a DNS record, wherein the DNS record is a hostname, a domain a DNS artifact, or a set of DNS records, wherein the client verifies a chain of trust associated with the digital signature, wherein the local root of trust is a trusted platform module or a virtual trusted platform module.

16. The non-transitory storage medium of claim 14, wherein the attestation keys are generated using endorsement keys, wherein digitally signing using attestation relieves the server of performing a key distribution process.

17. The non-transitory storage medium of claim 15, further comprising including properties of the attestation keys in the records, wherein the properties identify a level of security for the record that is digitally signed using the attestation keys, wherein the DNS record is signed using attestation to enable automation of digitally signing the DNS record that is repeatable at specified or non-specified intervals, further comprising verifying the signed DNS records at any point during runtime.

18. The non-transitory storage medium of claim 17, wherein the root of trust provides a quote on current records that includes a hash value for the current records, and digitally signs the quote, wherein the current records are validated by using the public key associated with the private key used to sign the current records, and information about the key pair is to determine a trustworthiness of the signature and the current records signed.

19. The non-transitory storage medium of claim 10, wherein the validation is local to the server, wherein the server is running DNS services, managing zone files and DNSSec records.

20. The non-transitory storage medium of claim 10, further comprising performing the validation through a remote attestation process wherein expected values are maintained by a party that performs the validation.
